(19) United States
(12) Patent Application Publication
(10) Pub. No.: US 2002/0059365 A1
(43) Pub. Date: May 16, 2002

(54) System for delivery and exchange of electronic data

(76) Inventors: Martin King, 6300 Zug (CH); Vladimir Rasin, Farmington Hills, MI (US)

Correspondence Address: SHOOK, HARDY & BACON, L.L.P., ONE KANSAS CITY PLACE, 1200 MAIN STREET, KANSAS CITY, MO, 64105-2118, US

(21) Appl. No.: 09/501,196

(22) Filed: Feb. 10, 2000

(51) Int. Cl. G06F 15/16

(52) U.S. Cl. 709/203

(57) ABSTRACT

An apparatus and method for delivering an electronic document, comprising of a sending device, which functions to send an electronic document, and at least one receiving device, which functions to receive the electronic document from the sending device. A network between said sending device and said at least one receiving device functions to allow said sending device to send a notification to said receiving device. The receiving device sends a notification to said sending device whereby said sending device forwards the electronic document to said receiving device. In the preferred mode, the sending device automatically records all notifications sent to and received from said receiving device, and the receiving device automatically records all notifications sent to and received from said sending device.

### BACKGROUND OF THE INVENTION

1. Field of the Invention

The present invention is a unique system for the delivery and exchange of electronic data. More particularly, the present invention is a system which functions to deliver data files and documents in a portable format to recipients over a communications link, in an expedient and reliable manner. When utilizing the system, a user sends a file or document to a plurality of others, yet the file or document need only be sent once irrespective of the number of receivers. Importantly, no buffering or storage between the sender and recipient is required for effective operation of the present system.

2. Description of the Prior Art

Numerous innovations for electronic data transfer systems have been provided in the prior art and are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

U.S. Pat. No. 5,883,901, invented by Chiu, et. al., titled “Communications system including synchronization information for timing upstream transmission of data and ability to vary slot duration”

In the patent to Chiu, a computer network for high-speed data communication has a data transmission cable with a root and at least one leaf node wherein the upstream transmission is synchronized by information received on a downstream channel. Each client station receives data on a first frequency band, and transmits data on a second frequency band according to signals received on the first frequency band. The client station's transmission packets may include requests for reserved slots on the second frequency band for subsequent transmissions, and the SCS has a scheduler operable to determine a start time for requested reserved slots, and transmits the start time for the requested reserved slots. The client stations are operable to wait to continue transmission after waiting for the start time.

U.S. Pat. No. 5,913,041, invented by Ramanathan, et. al., titled “System for determining data transfer rates in accordance with log information relates to history of data transfer activities that independently stored in content servers”

In the patent to Ramanathan, a method and system of monitoring throughput of a data access system includes logging each transfer of data from a content server to a remote site, with each log entry including information indicative of transfer size, date, times, source and destination. The method includes accessing the log information in a passive and non-intrusive manner to evaluate the performance of transfers to a selected subset of the remote sites. In another embodiment, the performance evaluation is implemented for system resource allocation planning. In the preferred embodiment, the data access system is a broadband data system and the content servers utilize Internet applications. Also in the preferred embodiment, the data throughput is measured by the transfer rate of useful data, rather than all data including retransmissions.

U.S. Pat. No. 5,826,269, invented by Hussey, titled “Electronic mail interface for a network server”

In the patent to Hussey, a networked system for processing queries for a server in a distributed processing environment is provided. The system includes a plurality of clients disposed for communication with a database server through an electronic mail system. The server includes an electronic mail interface for receiving queries submitted by the clients, and transmitting the corresponding response. A processor is also provided for processing the queries submitted from the clients, and submitting the queries on to the scheduler. The processor operates to provide bidirectional communication between the mail interface and the scheduler. In addition, the processor retrieves mail messages from the mail interface, translates them into a format recognized by the server, receives query results from the server, and returns the results with the appropriate user identification to the mail interface. A scheduler, provided in connection with the server, provides automated scheduled execution of the mail processor in accordance with a set of programmed tasks.

U.S. Pat. No. 5,734,833, invented by Chiu, et. al., titled “Shared communications channel with enhanced reservation and collision resolution protocols allows any subset of stations to transmit data after collision occurred in contention slot”

In the patent to Chiu, a system and method for collision resolution in a communication system having multiple transmission stations communicating on a shared slotted communication channel. The system and method includes a procedure for organizing the stations in a structure wherein each station has a fixed address corresponding to a static location in the structure. The procedure further indicates to the multiple transmission stations a slot type for each communication slot, the slot type selected from a group including contention slot type and reservation slot type, and accepts transmissions of contention slot data packets in contention slots on the communication channel from the stations, the contention slot data packets each optionally containing a reservation quantity for reservation slot data packets to be sent by an originating station upon successful transmission of a contention slot data packet originating at the originating station, the reservation slot data packets transmitted in reservation slots dedicated to the originating station. The procedure detects collisions in the transmissions of packets originating from the transmitting station with packets transmitted from other transmitting stations; and upon detecting a collision in a contention slots, recursively entitles a subset of the locations in the structure to transmit in the subsequent contention slot regardless of whether the station transmitted during the contention slot in which the collision occurred, wherein membership in the subset indicates that a station corresponding to a location in the subset is entitled.

U.S. Pat. No. 5,940,823, invented by Schreiber, et. al., titled “System for the distribution and storage of electronic mail information”

In the patent to Schreiber, a system and method for distribution and storage of electronic mail information is disclosed. The system comprises: a server; a status rendezvous procedure (102) residing on the server; and a distribution storage facility comprising a distribution management system (112) residing on the server; and a container management system (114) residing on the server. The method for distribution and storage of electronic mail information comprises the following steps: (1) receiving inbound information from a first remote connection, the inbound information comprising a distribution; (2) processing the distribution, the processing resulting in the distribution being stored in memory; (3) writing the distribution to a storage medium; (4) paging the distribution from the storage medium into memory; (5) passing a part of the distribution in memory to at least a second remote connection; and (6) determining an intended recipient in response to the presence of a reported recipient.

U.S. Pat. No. 5,835,762, invented by Gans, et. al., titled “Method and apparatus for processing electronic mail in parallel”

The Gans invention provides a method and apparatus for processing electronic mail in parallel. The present invention provides the ability to process mail objects in an electronic mail system in parallel. A message can be assigned to a queue. One or more processes can manage a plurality of messages in the queue. Each process can identify the next entry to be processed. Entries previously processed can be marked such that subsequent access is locked out. Mail objects and process information can be stored in a relational database system that provides the ability to perform locking at the record level. A process can be configured to perform a plurality of activities in a plurality of time periods. A guardian process can initiate or terminate other processes based on process information. Further, a guardian process examines system information periodically and identifies any need to initiate, restart, or stop one or more processes. Further, the guardian process can pass process information to an initiated process. One or more tables can be used to retain message information such as a instance table that includes a queue column. Further, tables can be used to retain process information such as process, process parameters, and process time tables.

U.S. Pat. No. 5,764,898, invented by Tsuji, et. al., titled “System for task tracking and controlling electronic mail”

In the patent to Tsuji, an office information system has a plurality of work stations connected via a network to mutually exchange electronic mail, each work station including a control information definition unit for defining control information representing what kind of processing can be performed on mails after reception, a processing log memory unit for storing log information of operations which have been performed on received mail, a control unit for guiding a receiver by referring to both the control information and log information, a task tracking instruction unit for inquiring into the processing status of mail, and a task tracking unit for reporting the status in response to such a tracking instruction. The system stores and interprets control information relating to the flow of an OA object on the network, which has been conventionally involved in the memory of an office worker, and guides the office worker to work to be done by the office worker. As a result, the chance that the OA object will stagnate at a certain location is reduced, and the circulation of OA objects on the network is improved.

U.S. Pat. No. 5,632,018, invented by Otorii, titled “Electronic mail system”

In the patent to Otorii, a user who received a broadcast message broadcasts a response answering the broadcast message. Sender Y of the broadcast message sends to an electronic mail system through the broadcast message together with identification information on addressees of the broadcast message, and then issues a request to broadcast the message. The electronic mail system sends the message together with the identification information on the addressees of the message to each terminal of users A, B and C as specified by sender Y. On receiving the message, user A generates a response answering the received message, and sends it to the electronic mail system. User A also sends to the electronic mail system the identifiers of users B and C as identification information on addressees of the response according to the received identification information on the addressees of the broadcast message, and then requests the system to broadcast the response. Then, the electronic mail system sends the response to users B and C and sender Y. Thus, user A can be informed of other receivers of the broadcast message and sends the response to users B and C without a troublesome operation of inputting addresses of the response.

U.S. Pat. No. 5,508,817, invented by Kunigami, titled “Electronic mail accounting system” In the patent to Kunigami, when sending electronic mail, a sender designates the payer of the communications fee for the transmission between an electronic mail center and a receiver, that is, the sender or the receiver. When the receiver accesses the electronic mail center, the electronic mail center notifies as the mail summary information for each mail the payer of the fee for the communication between the electronic mail center and the receiver. The fee payer information is displayed on the terminal of the receiver. When the receiver receives from the electronic mail center the electronic mail addressed to him, the electronic mail center generates a bill according to the fee required for the delivery of the electronic mail separately for senders and receivers. In this case, the communications fee for the transmission between the electronic mail center and the receiver is charged to the payer designated by the sender when the electronic mail is sent.

U.S. Pat. No. 5,424,724, invented by Williams, et. al., titled “Method and apparatus for enhanced electronic mail distribution”

The patent to Williams describes a method and apparatus for enhanced electronic mail distribution which permits expeditious distribution of electronic mail documents to multiple host systems and/or external networks via a single host agent. A distributed data processing system having multiple host systems and/or external networks permits electronic mail documents to be distributed from local networks to nodes within various host systems or networks by establishing a host agent reference table at selected host agents within the local network. Each host agent reference table includes an identification of selected destination nodes associated with an identified host agent for those nodes. A referral to the host agent reference table may then be utilized to determine the appropriate host agent for an electronic document destined for a selected node. Thereafter, existing interprocess local network communications may be utilized to communicate the electronic document to the appropriate host agent. In the depicted embodiment of the present invention a default host agent may also be listed within the host agent reference table for all destination nodes not explicitly listed within the table. Additionally, an ordered list of likely host agents may be established and utilized sequentially in a selected order for unlisted destination nodes, in response to a failure of a document to achieve a confirmation of delivery within a specified period of time.

As outlined above, other prior art patents that relate to advanced electronic mail systems largely entail storage or buffer means which act as an intermediary between the sender and the recipient. In addition, it should be noted that although several prior art patents teach the usage of scheduling devices, no patent provides the same in the context of direct file or document delivery at previously determined time slots, according to bandwith specifications and slot availability.

In general, regarding the most relevant prior art, the development of electronic information delivery and exchange, such as that provided through the Internet or other computer-networked systems, has led to the proliferated use of electronic mail or e-mail as a solution to sending messages from one Internet-connected device to another.

However, an inherent problem in document delivery and exchange on electronic networks is that such is primarily based upon two basic forms of information exchange. The first is considered a “push” style, whereby the act of the user connecting to a network access point is detected and information is automatically sent to the user from a storage source. This style has become quite popular with Internet service providers, who seek to provide their customers the easiest systems to operate and still maintain in an expeditious manner. The second is considered a “pull” style, whereby the connected user requests specific information or messages from a storage source and the information is transferred to the user. This style is also popular, as users can dictate the point in time at which messages are delivered to their system when the user has ample time to read the messages or data.

In each of the above instances, information may be stored at the main source, or alternatively may be stored at a local point of presence, known as a “POP,” or centralized server to the user. This inevitably leads to restrictions upon transferred document size due to the limited amount of storage available on the local POP or central server. Such acts as a practical limitation upon electronic mail usage by large and small businesses, who frequently need to send sizable documents to other companies, clients, and even to various in-house departments of the same corporation. Such similarly acts as a significant limitation to those who regularly transfer graphic information, such as two-dimensional or three-dimensional artwork to one another. Likewise, the rapidly growing field of animated artwork and transfer of moving images is significantly curtailed by the inability of the local server to effectively store all contents of the same.

As another distinct problem, such also leads to duplication and storage of data on third party devices, unfortunately forming a significant security risk for end-users. Stated simply, the sender in such a system does not have any indication of where the document is at a particular time and likewise has no indication of whether the user has received it. In addition, the sender does not have any indication if there has been a breach of security and whether the person who has received the document was an unintended recipient. One can understand that such uniformly discourages the sending of vital or sensitive documents via electronic mail, even though such medium often represents the fastest manner in which to transfer any information from a first party to a second party.

Generally speaking, the disclosed prior art systems and methodologies provide some methods of document delivery and exchange, but fail to provide an economical and scaleable solution to the aforementioned problems. In particular, the prior art fails to provide a system that is limited only by the capacity and speed of the network connection and devices relied upon by the receiver and sender, while still conserving the integrity and security of the source electronic data in question.

The electronic document delivery system outlined in this disclosure represents a major technological advancement which enables users to distribute portable documents to many recipients in a controlled, secure, and economical manner—all with a guaranteed level of service that was previously unavailable to users.

In contrast to the prior art, the present invention utilizes a unique channel management component, which controls and supervises channels defined on the network. The channel management component, using an addressing and bandwith reservation scheme, searches for a next available time to send a requested file according to information previously specified by the user. This allows the system of the present invention to provide a common interface for distribution and exchange of data with a guaranteed speed of transfer, while creating both the utmost in security and a guaranteed level of service that modem users need.

Moreover, the present invention allows the sender to receive tracking information regarding receipt of the messages, enhancing the overall value of the system. Indeed, such tracking and accounting ability allows for the utmost in office efficiency, as senders need not make time consuming follow-up telephone calls or supplemental electronic messages simply to verify receipt of prior data and information sent.

### SUMMARY OF THE INVENTION

As previously noted, the present invention is a system which functions to deliver data files and documents in a portable format to recipients in a quick and reliable manner. In the primary mode, a user sends a file or document to a plurality of other users, yet the data need only be sent once regardless of the number of intended receivers. Importantly, no buffering between the sender and recipient is required in any way.

To accomplish the foregoing, the system relies primarily upon the following elements: a file transfer component; a timer component; the aforementioned channel management component; and a bandwith database. As previously noted, the channel manager controls and supervises channels defined on the network using a unique addressing and bandwith reservation scheme. This allows users to specify the exact manner in which they would like messages transmitted, including transfer speed and time of sending. The system arranges for delivery with terms and conditions as close to the user's specifications as practically possible.

In total, the object of the invention is to provide a unique common interface for distribution and exchange of electronic data with a guaranteed speed of data transfer, while achieving the utmost in security. Thus, distribution is performed in a controlled, secure, and economical manner, with a guaranteed level of service that was previously unavailable. In preferred embodiments, the invention also permits the sender to receive accounting or tracking information from the receivers regarding the precise status of the electronic message, functioning to allow for enhanced overall security through usage of the present system.

### BRIEF DESCRIPTION OF PREFERRED EMBODIMENTS

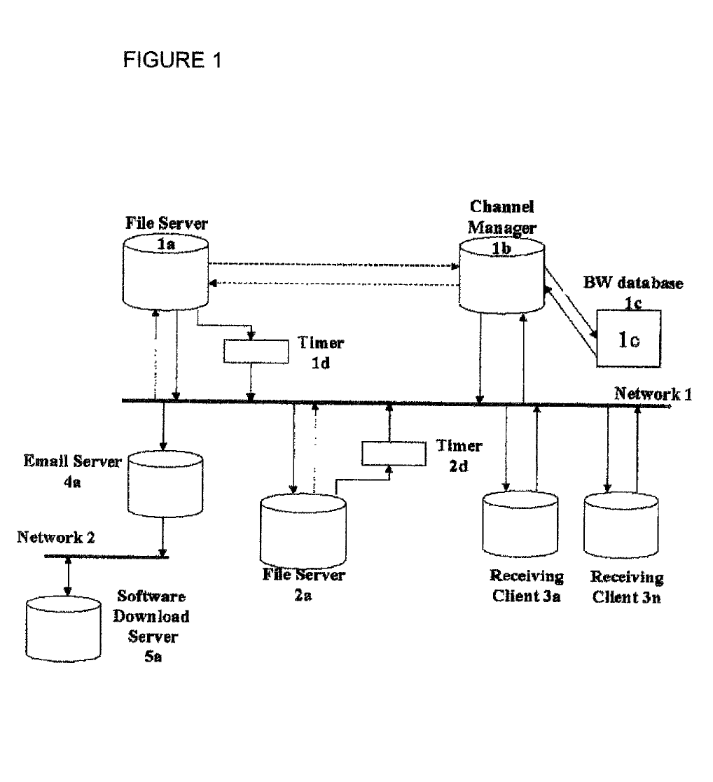

FIG. 1 is a block diagram of the specific components within the present invention system architecture, provided for the purposes of simplicity and overall construction.

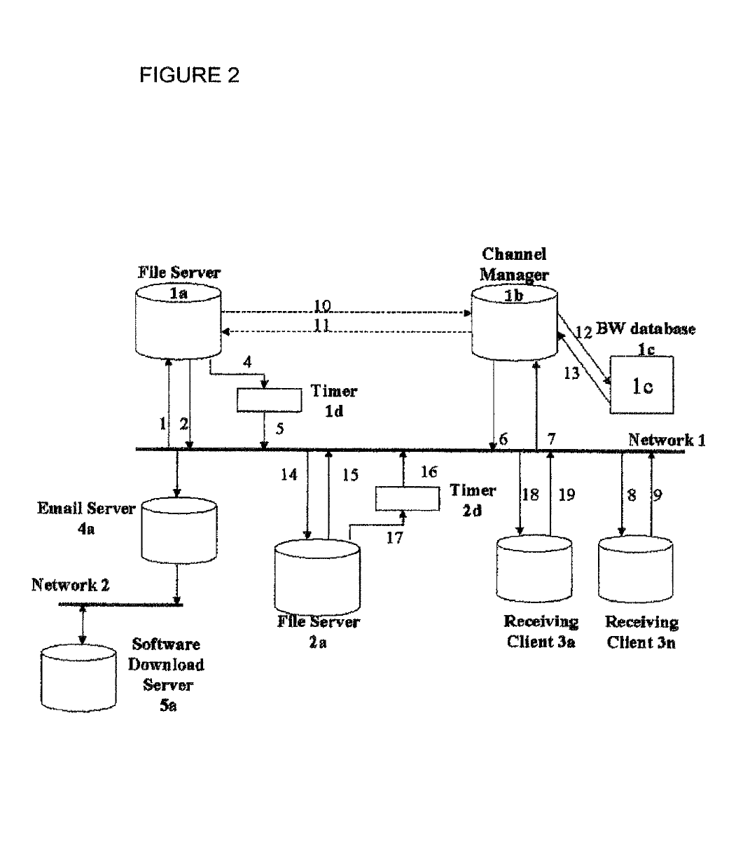

FIG. 2 is a block diagram of the specific components within the present invention system architecture, enhanced to include numerical labels identifying the particular flow of information in the preferred mode.

### DETAILED DESCRIPTION OF THE PREFERRED EMBODIMENT

As noted, the object of the invention is to provide a common interface for the distribution and exchange of electronic multimedia data in a community of users with a guaranteed speed of data transfer.

Thus, a system is disclosed for the purpose of quickly and reliably delivering data files and documents in a portable format to one or more recipients over a communications link. The method includes the sending of data, whereby a user sends a document to a plurality of other users who constitute a community. The data file or document need only be sent once irrespective of the number of receiving clients. No buffering or storage between the sender and the receiver is required. In preferred embodiments, the invention permits the sender to receive accounting information from the receivers.

The speed of data transfer to the receiving users is guaranteed by the automatic allocation and management of network capacity. In preferred embodiments, the invention permits the sender to receive accounting information from the receivers

FIG. 1 provides a block diagram of the specific components within the system architecture, provided for the purposes of simplicity and overall construction. FIG. 2 provides a block diagram of the specific components within the system architecture, enhanced to include numerical labels identifying the particular flow of information in the preferred mode.

Illustrated is a single sending component consisting of a file transfer component 1a, a timer component 1d, a channel management component 1b, and a bandwidth database 1c. Also shown are a plurality of client devices 3a and 3n. Such devices are capable of receiving various data packets from system 1. Importantly, the devices are interconnected via network 1, which permits effective transportation of any such data packets.

The channel manager 1b controls and supervises channels defined on the network using a unique addressing and bandwidth reservation scheme. The use of bandwidth on a given channel is monitored through the use of bandwidth database 1c.

Thus, a first principal aspect of the invention relates to file publishing, or the providing of data or information to be transferred to a second user. If a user wishes to publish a data file to a number of other devices attached to the network to a group of users, the following method is applicable. In the preferred mode, the user initializes the process through an event such as a keyboard input or mouse click. Alternatively, voice recognition software may be utilized for the purposes of quickness and efficiency. File server 1a is assigned to a channel where a plurality of receiver devices is attached. File server 1a then requests approval 10 or authorization from the channel manager 1b that sending is appropriate at such time.

The file server sends such request, indicating the size of the file and the bandwidth, if available, with which the user waits to transmit the file. The channel manager 1b then requests from the bandwidth database 1c to find the most optimal time for transfer and further to ensure that the channel has sufficient free bandwidth that the file may be transmitted at the particular full speed requested on that channel. The channel manager 1b calculates precisely how long it will take to send the file to its desired destination. The channel manager 1b searches 12 in the bandwidth database 1b or the closest available time to the time requested by the user, to send the file at the recommended or given speed.

Upon completion of the search 13, the channel manager 1b replies 11 to the file server 1a with the time at which the server is available to transmit the particular data. In the event of a busy response, the channel manager will reply that there is not sufficient free bandwidth to satisfy this specific request. The file server 1a then sets 4 the timer 1d. Upon expiration of the period allocated to timer 1d, the file server 1a sends the file on the assigned channel. Such expiration will occur at a previously determined time interval consistent with the goals of the most optimal transfer of data possible. Importantly, the system provides a means for a single attached device to run multiple file server processes to different attached network groups, for the purposes of efficiency and organization of data or information.

Should the user wish to publish to a plurality of users on another network, such as the Internet or other global computer network which is represented by network 2, the user can automatically issue a secure e-mail message over network 1. Such will be resent by e-mail server 4a. The e-mail message may contain the configuration information that allows a user who is not a member of network 1 to download a receiving software from a software download server 5a, that permits connection to network 1 for request of said data.

A second principal aspect of the invention relates to file requesting. In the preferred mode of operation, a user of end-user device 3a wishes to request a data file from file server 1a or 2a. The user initializes the following process through an event such as a keyboard input or mouse click. Once again, a voice recognition program may also be utilized for efficiency and convenience purposes.

Then, the client with requesting functionality sends a specific request 9 on the channel, with the path of the requested file included. This request 9, indicating the size of the file, the recommended bandwidth, and the location of the file requested, comes to all file servers 1a and 2a enabled to reply to requests. If file server 1a or 2a maintains this file locally, it will send request 2 or 15, indicating the size of the file and the bandwidth with which the user wants to request the file, for approval to transmit this file to the channel manager 1b. Importantly, the channel manager 1b ensures that only one file server will reply.

The channel manager 1b then requests 12 from the bandwidth database 1c to find the time, and to ensure that the channel has enough free bandwidth, such that the file may be transmitted at the full speed requested on the channel. Accomplishing this task at the full speed will of course maintain the integrity and overall utility of the electronic mail system utilized. Using all available information, the channel manager 1b calculates precisely how long it will take to send the file as requested. The channel manager 1b then searches 12 in the bandwidth database 1b for the closest available time to the time requested by the user to send the file at the determined speed.

Upon completion of the search 13, the channel manager 1b replies 6 to the file server 1a or 2a with the time when the server can transmit data, or with a busy response, if there is not enough free bandwidth to satisfy this request. The file server 1a or 2a sets 4 or 17 the timer 1d or 2d and forwards the time of transmission 5 or 16 to the requesting client. Upon expiration of a client timer, the client 3a or 3n sends a second request, with an indication that such is the second request, to the appropriate file server 1d or 2d. The file server 1a or 2a will send the file on the assigned channel without any further delay. As such, this aspect of the system can be expected to effectively satisfy those users whose electronic messages are the most time-sensitive in nature, allowing for same to be transmitted as soon as practically possible.

Finally, it should be noted that the variety of aforementioned techniques may be applied for delivery of electronic documents over virtually any kind of network, and between virtually any kind of devices, greatly enhancing its overall utility. To use one common industry example, such includes asymmetric networks where the forward and return channels may be realized using two simplex channels—one operating from the source to the sender and the other from the sender to the source.

Moreover, with regards to both FIGURES and all descriptions herein, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will fully reveal the gist of the invention so that others can adapt it for various applications without omitting features that, from the standpoint of prior art, constitute essential characteristics of the generic or specific aspects of the invention. What is claimed as new and desired to be protected by Letters Patent is set forth in the appended claims.

What is claimed is:

1. An apparatus for delivering an electronic document, comprising of:
A. a sending device, which functions to send an electronic document;
B. at least one receiving device, which functions to receive the electronic document from the sending device; and
C. a network between said sending device and said at least one receiving device, functioning to allow said sending device to send a notification to said receiving device, and wherein said receiving device sends a notification to said sending device whereby said sending device forwards the electronic document to said receiving device.

2. The apparatus for delivering an electronic document as described in claim 1, wherein said sending device automatically records all notifications sent to and received from said receiving device, and whereby said receiving device automatically records all notifications sent to and received from said sending device.

3. The apparatus for delivering an electronic document as described in claim 1, wherein the network functions to allow said sending device to send a notification to a plurality of receiving devices, wherein each receiving device sends a notification to said sending device, and whereby said sending device waits for a notification, and whereby said sending device forwards the electronic document to the plurality of receiving devices in a single multicast transmission, and whereby said sending device automatically records all notifications sent to and received from said receiving device, and whereby said receiving device automatically records all notifications sent to and received from said sending device.

4. The apparatus for delivering an electronic document as described in claim 1, wherein said sending device waits for a time-out of collection of said notifications and forwards the electronic document to the plurality of said receiving devices in a single multicast transmission.

5. The apparatus for delivering an electronic document as described in claim 1, wherein the network functions to allow said sending devices to send a notification to said receiving device in a single multicast transmission, wherein each receiving device downloads the electronic document from said sending device, and whereby the sending device automatically records all notifications sent to and received from said receiving device, and each receiving device automatically records all notifications sent to and received from said sending device.

6. The apparatus for delivering an electronic document as described in claim 1, wherein the network functions to allow said sending device to send a document to said receiving device, wherein said receiving device sends a notification to said sending device, whereby said sending device automatically records all notifications sent to and received from said receiving device, and said receiving device automatically records all notifications sent to and received from said sending device.

7. The apparatus for delivering an electronic document as described in claim 1, wherein the network functions to allow said receiving device to send a notification searching for said sending device, wherein said sending device replies with a notification of time when network capacity is substantially free to said receiving device, said receiving device then requests at the notified time directly to said sending device, whereby said sending device will forward the electronic document to said receiving device, and whereby said sending device automatically records all notifications sent to and received from said receiving device, and said receiving device automatically records all notifications sent to and received from said sending device.

8. The apparatus for delivering an electronic document as described in claim 1, wherein said receiving device is one of a community of receiving devices

9. The apparatus for delivering an electronic document as described in claim 8, wherein a single receiving device sends a notification searching for said sending device wherein the sending device replies with a notification of time when network capacity is free to said receiving device or the community of receiving devices, and said receiving device then requests at the notified time directly to said sending device, whereby the said sending device will forward the electronic document to the community of said receiving devices in a single multicast transmission, whereby said sending device automatically records all notifications sent to and received from said receiving device, and said receiving device automatically records all notifications sent to and received from said sending device.

10. The apparatus for delivering an electronic document as described in claim 1, wherein said receiving device is not a member of a sending devices community

11. The apparatus for delivering an electronic document as described in claim 10, wherein said sending device sends a notification to said receiving device comprising a direct reference to become a member of a sending device community, wherein said receiving device executes the direct reference and becomes a member of said sending device community, whereby said sending device automatically records all notifications sent to and received from said receiving device, and said receiving device automatically records all notifications sent to and received from said sending device.

12. An apparatus for automatic management and allocation of network traffic based on requests to use network capacity comprising of:
A. a sending device, which functions to send an electronic document;
B. a database which functions to store reservations for sending the electronic document;
C. a channel manager, which comprises a plurality of algorithms which function to calculate a time to send the electronic document;
D. at least one receiving device, which functions to receive the electronic document; and
E. a network between said sending device and receiving devices, wherein transactions to send document transfers are managed through a channel manager and a bandwidth database, wherein said sending device automatically records all notifications sent to and received from said receiving device, and whereby said receiving device automatically records all notifications sent to and received from said sending device.

13. A method of delivering an electronic document, comprising of:
A. a sending device, which functions to send an electronic document;
B. at least one receiving device, which functions to receive the electronic document from the sending device; and
C. a network between said sending device and said at least one receiving device, the network functioning to allow said sending device to send a notification to said receiving device, wherein said receiving device sends a notification to said sending device, whereby said sending device forwards the electronic document to said receiving device, whereby said sending device automatically records all notifications sent to and received from said receiving device, and whereby said receiving device automatically records all notifications sent to and received from said sending device.

14. The method of delivering an electronic document as described in claim 13, wherein the network functions to allow said sending device to send a notification to a plurality of receiving devices, wherein each receiving device sends a notification to said sending device, whereby said sending device waits for a notification, whereby said sending device forwards the electronic document to the plurality of receiving devices in a single multicast transmission, whereby said sending device automatically records all notifications sent to and received from said receiving device, and whereby said receiving device automatically records all notifications sent to and received from said sending device.

15. The method of delivering an electronic document as described in claim 13, wherein said sending device waits for a time-out of collection of said notifications and forwards the electronic document to the plurality of said receiving devices in a single multicast transmission.

16. The method of delivering an electronic document as described in claim 13, wherein the network functions to allow said sending devices to send a notification to said receiving device in a single multicast transmission, wherein each receiving device downloads the electronic document from said sending device, and whereby the sending device automatically records all notifications sent to and received from said receiving device, and each receiving device automatically records all notifications sent to and received from said sending device.

17. The method of delivering an electronic document as described in claim 13, wherein the network functions to allow said sending device to send a document to said receiving device, wherein said receiving device sends a notification to said sending device, whereby said sending device automatically records all notifications sent to and received from said receiving device, and said receiving device automatically records all notifications sent to and received from said sending device.

18. The method of delivering an electronic document as described in claim 13, wherein the network functions to allow said receiving device to send a notification searching for said sending device, wherein said sending device replies with a notification of time when network capacity is substantially free to said receiving device for the purposes of transmission, said receiving device requesting the notified time directly to said sending device, said sending device forwarding the electronic document to said receiving device, and whereby said sending device automatically records all notifications sent to and received from said receiving device, and said receiving device automatically records all notifications sent to and received from said sending device.

19. The method of delivering an electronic document as described in claim 13, wherein said receiving device is one of a community of receiving devices

20. The method of delivering an electronic document as described in claim 19, wherein a single receiving device sends a notification searching for said sending device, the sending device replies with a notification of time when network capacity is free at least one receiving device, and said receiving device then requests the notified time directly to said sending device, whereby the said sending device will forward the electronic document to the at least one receiving device in a single multicast transmission, whereby said sending device automatically records all notifications sent to and received from said receiving device, and said receiving device automatically records all notifications sent to and received from said sending device.

21. The method of delivering an electronic document as described in claim 13, wherein said receiving device is not a member of a community of sending devices.

22. The method of delivering an electronic document as described in claim 21, wherein said sending device sends a notification to said receiving device comprising a direct reference to become a member of a community of sending devices, wherein said receiving device executes the direct reference and becomes a member of community of sending devices, whereby said sending device automatically records all notifications sent to and received from said receiving device, and said receiving device automatically records all notifications sent to and received from said sending device.

23. A method for automatic management and allocation of network traffic based upon requests to use network capacity, the method comprising the steps of:
A. a sending device functioning to send an electronic document;
B. a database storing reservations;
C. a channel manager comprising a plurality of algorithms calculating a time at which to send the document;
D. at least one receiving device receiving the electronic document; and
E. a network between said sending devices and said receiving devices, wherein all transactions for document transfers are managed through a channel manager and bandwidth database, said sending device automatically recording all notifications sent to and received from said receiving device, said receiving device automatically recording all notifications sent to and received from said sending device.
